(19) United States
(12) Patent Application Publication
(10) Pub. No.: US 2006/0244296 A1
(43) Pub. Date: Nov. 2, 2006

(54) Infinitely variable continuous recliner mechanism for vehicle seats and similar applications

(76) Inventor: Michael Drew, Milton Keynes (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/552,342

(22) PCT Filed: Apr. 5, 2004
(86) PCT No.: PCT/GB04/01490

§ 371 Date: Nov. 21, 2005

(30) Foreign Application Priority Data
Apr. 7, 2003 (GB) 0307987.8
Sep. 4, 2003 (GB) 0320721.4

(51) Int. Cl. B60N 2/02

(52) U.S. Cl. 297/362

(57) ABSTRACT

A seat recliner mechanism for a seat having a seat cushion and a reclinable squab includes a stationary hinge member (1) connectable with the seat cushion, an adjustable hinge member (2) connectable with the squab and an angular position adjuster in the form of a wobble gear mechanism. The wobble gear mechanism includes an inner gear (7) connected to one of the hinge members (1), an outer gear (10) connected to the other hinge member (2) and an eccentric rotatable drive element (5) for causing eccentric rotation of the inner gear (7) within the outer gear (10). The outer gear (10) has one more tooth than the inner gear (7) and the inner and outer gears have conformal tooth profiles, whereby all but one of the teeth on the inner gear (7) engage with teeth on the outer gear (10).

The present invention relates to a continuously variable recliner mechanism for vehicle seats and similar applications.

Typically in vehicle seats the two main components are the seat cushion, which is the part one sits on, and the seat squab (or backrest), which is the part one leans against. It is normal for the angle between the cushion and the squab to be adjustable so that the seated occupant can obtain maximum comfort. This is because the body shape and size of occupants can vary greatly. It is also desirable to have a facility for reclining the seat squab, so that the occupant can rest in a more horizontal position.

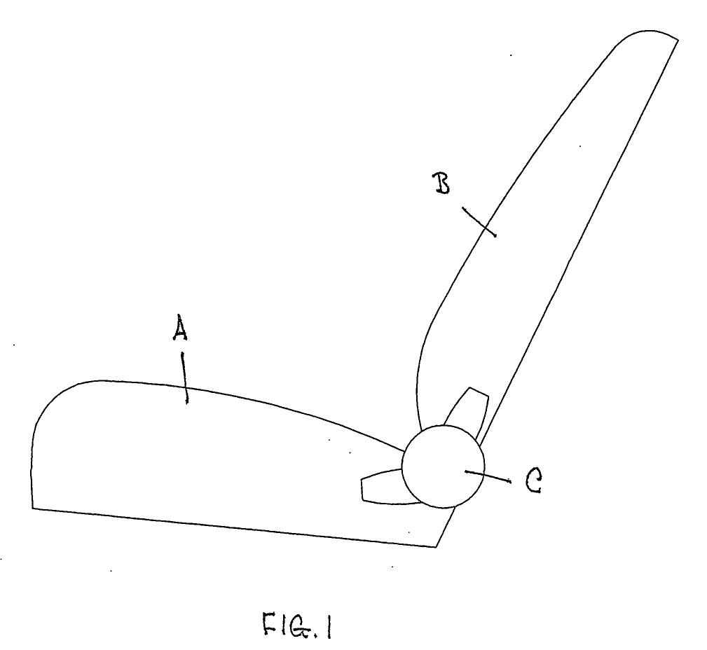

To achieve this feature it is normal to provide a recliner mechanism having one part that is attached to the seat cushion and another part that is attached to the seat squab, as shown in FIG. 1. Sometimes a single recliner mechanism is used on one side of the seat with a simple pivot on the other side for low load/strength applications. Conversely, for high strength seats, recliner mechanisms are fitted on both sides.

There are a number of recliner mechanisms used throughout the world but in general terms the range of mechanisms used can be divided into two different types.

The first type of recliner mechanism is what is called a ratchet type recliner and is operated by the raising and lowering of a lever. These work by raising the operating lever to release a locking mechanism, resetting the squab angle and then lowering the lever to relock the mechanism. What this does is to engage a new position on a set of teeth internally within the mechanism. Two disadvantages of the ratchet type recliner are:
a) The angle of recline has increments of movement normally of about 3 degrees owing to the form of the teeth. This means for example that the seat cannot be set 2 degrees forwards or backwards from a locked position. CONFIRMATION COPY
b) When the lever is raised to unlock the mechanism, the internal teeth are disengaged and the recliner should not therefore be operated while the vehicle is in motion.

The second type of recliner mechanism uses a gear mechanism that has a continual mesh and provides a continuously variable adjustment range. Normally these mechanisms are operated by manual hand wheels although on more expensive seats, electric motors are often employed. Basically by turning a hand wheel or operating an electric switch the squab is powered backwards or forwards. When the seat back is moving forwards or backwards the recliner mechanism remains continuously in mesh and can be stopped in any position within a continuously variable range of adjustment.

It can now be readily appreciated that the second type of mechanism overcomes the disadvantages already outlined for the first type.

The second type of mechanism comes in a range of different designs. These include designs incorporating a worm and wheel system, and others that incorporate a planetary gear system where the planetary gears are meshed with internally stamped gear rings. However, the simplest and most successful of all of the continuously variable types of recliner mechanism is the well tried and tested ‘Taumel’ system as manufactured by Keiper Recaro of Germany.

The main principle of the Keiper Recaro mechanism concerns the use of a wobble gear mechanism comprising a pair of inner/outer fine blanked tooth rings, which provide the angular adjustment of the seat squab by rotating eccentrically relative to one another with a wobbling or waltzing movement. Another feature of the Keiper Recaro Taumel mechanism relates to the use of a wedge device, which is necessary in order to reduce play (chuck) in the seat squab and creep (the slow lowering of the squab under its own weight).

According to the present invention there is provided a seat recliner mechanism for a seat having a seat cushion and a reclinable squab, the mechanism including a stationary hinge member connectable with the seat cushion, an adjustable hinge member connectable with the squab and an angular position adjuster in the form of a wobble gear mechanism including an inner gear connected to one of the hinge members, an outer gear connected to the other hinge member and an eccentric rotatable drive element for causing eccentric rotation of the inner gear within the outer gear, wherein the outer gear has one more tooth than the inner gear and the inner and outer gears have conformal tooth profiles, whereby all but one of the teeth on the inner gear engage with teeth on the outer gear.

The present invention provides an improved recliner mechanism that allows continuous adjustment of the seat squab and does not require a wedge or similar mechanism to prevent play and creep.

In particular, because nearly all of the teeth on the gear mechanism are engaged, there is very little play and creep. The mechanism is also very strong, since the forces are carried by many teeth. This allows ordinary structural steel to be used without any need for case hardening, which in turn allows the recliner mechanism to be welded direct to the frame of a seat without requiring expensive adaptors.

Advantageously, the maximum peak-to-peak gap between the teeth of the inner and outer gears is less than 0.15 mm, preferably less than 0.1 mm. For example, the maximum peak-to-peak gap may be approximately 0.09 mm. This provides play at the top of a 500 mm squab of less than 1 mm, which is within acceptable limits.

The inner and outer gears preferably have a tooth form similar to a Wildhaber-Novikov tooth form.

The rotatable drive element preferably includes an eccentric cam. Advantageously, the cam surface of the eccentric cam is partly cut away, preferably at an angle of approximately 120°. This provides two contact points and improves the stability of the cam.

Advantageously, the rotatable drive element is mounted in a frusto-conical bearing.

Preferably, the frusto-conical bearing has bearing surfaces inclined at an angle of 7-10°, preferably approximately 90, relative to the rotational axis of the bearing. The provision of a frusto-conical bearing reduces play in the mechanism still further. It also helps to prevent jamming of the mechanism and relieves hard spots (spots where the control knob is difficult to turn).

A compressible element is preferably compressed between the rotatable drive element and one of the hinge members. The compressible element may consist of a plastics ring or a wave spring. The compressible element provides a frictional force which prevents unintentional rotation of the drive element, thereby preventing creep. Also, when the rotatable drive element is mounted in a frusto-conical bearing, the compressible element provides an axial force urging the rotatable drive element against the bearing, to reduce play.

Advantageously, the seat recliner mechanism has a secondary gear mechanism that includes a secondary inner gear connected to one of the hinge members and a secondary outer gear connected to the other hinge member, said secondary inner and outer gears being arranged to come into engagement only when the recliner mechanism is deformed. This provides additional strength, preventing the recliner mechanism from collapsing when subjected to very large loads, for example in the event of a collision.

Advantageously, the gears are semi-sheared out of the hinge members.

The hinge members preferably include welding tabs for welding the seat recliner mechanism direct to frame members of the seat cushion and squab. This makes assembly of the seat very simple and avoids the need for adaptors.

The basic structure of both the new recliner mechanism and the Keiper Recaro recliner is very simple, and consists of essentially of two plates produced by the ‘fine blanking technique’ or similar. One plate is attached to the seat cushion and has an inner gear with an external tooth form pressed into it by fine blanking or a similar process. The other plate is attached to the seat squab and into this plate an outer gear with an internal tooth form is pressed by fine blanking or similar. The plate with the internal tooth form contains one more tooth than the plate with the external tooth form. A centrally placed eccentric cam drives the mechanism in a clockwise or anti-clockwise direction. The new recliner mechanism differs fundamentally from the Keiper Recaro recliner in the provision of a conformal tooth form, which provides the advantages set out above.

Various embodiments of the present invention will now be described, by way of example, with reference to the accompanying drawings, in which:

FIG. 1 is a schematic side view of a vehicle seat having a recliner mechanism;

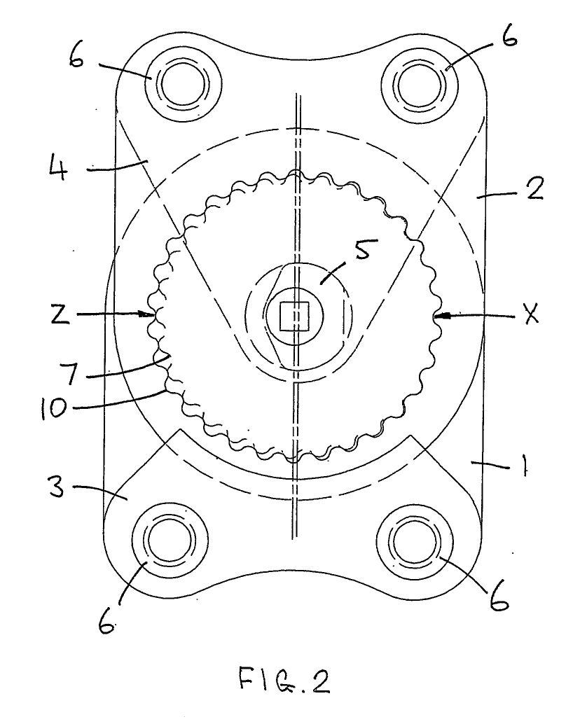

FIG. 2 is a side view of a first recliner mechanism;

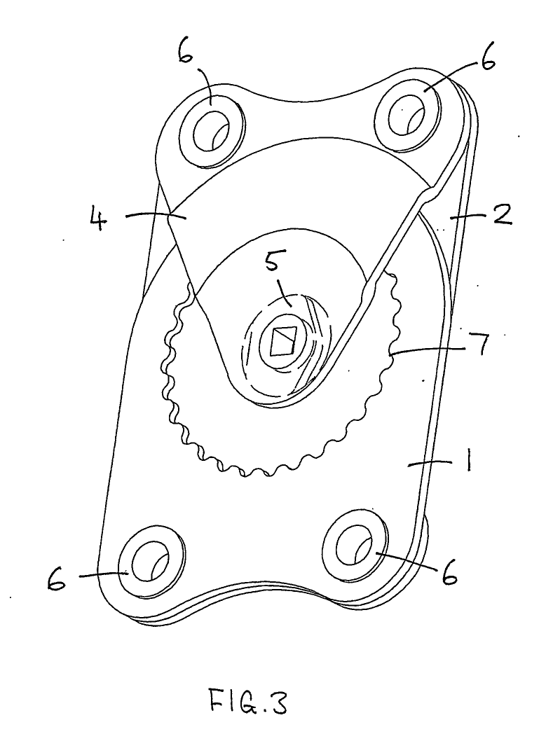

FIG. 3 is a first isometric view of the first recliner mechanism;

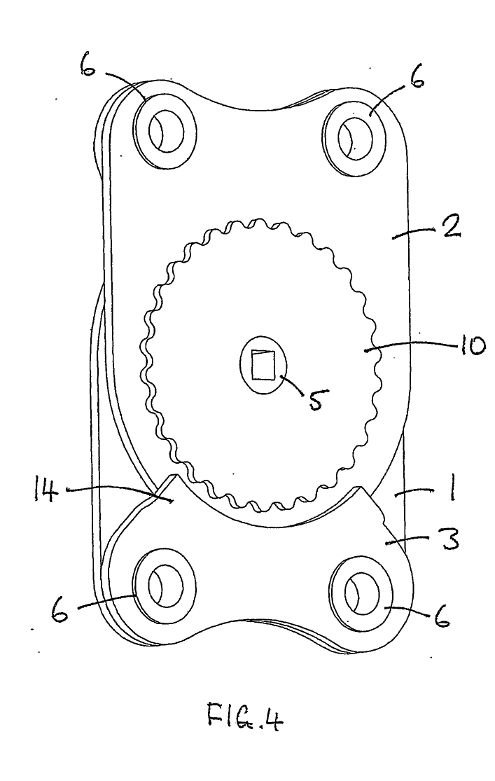

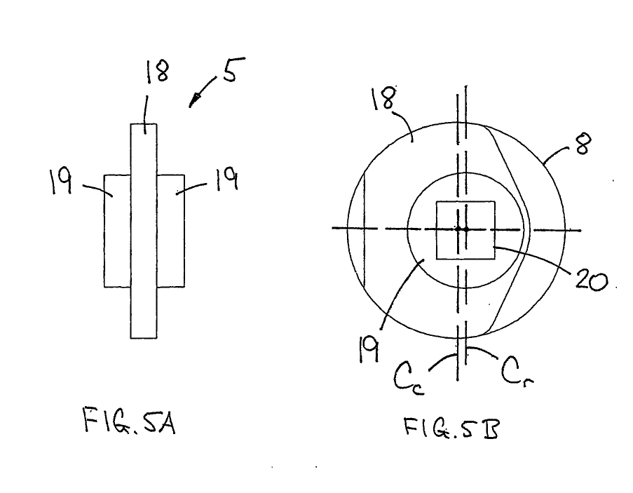

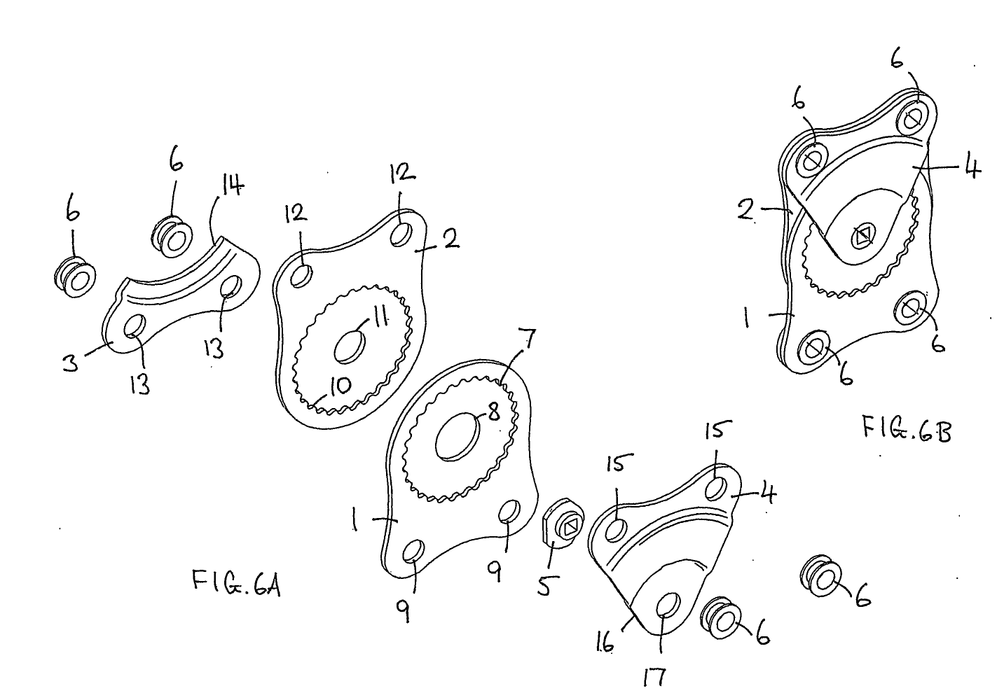

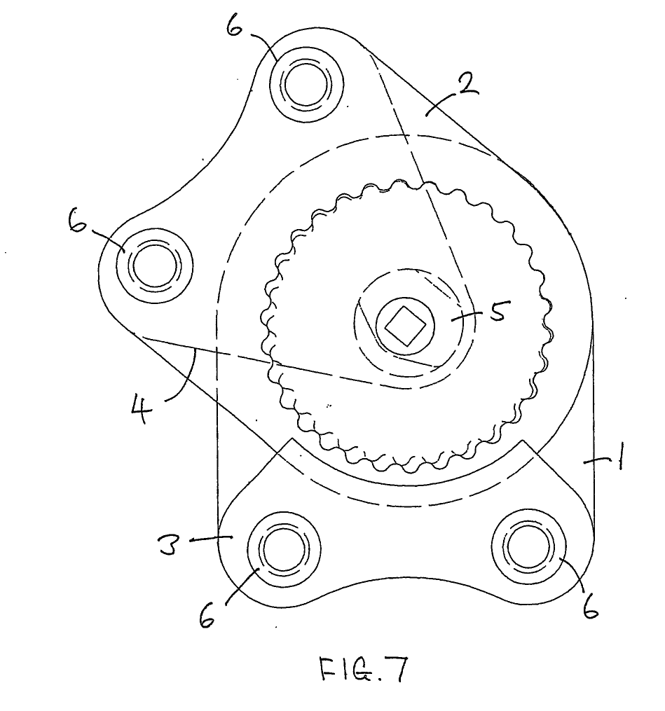

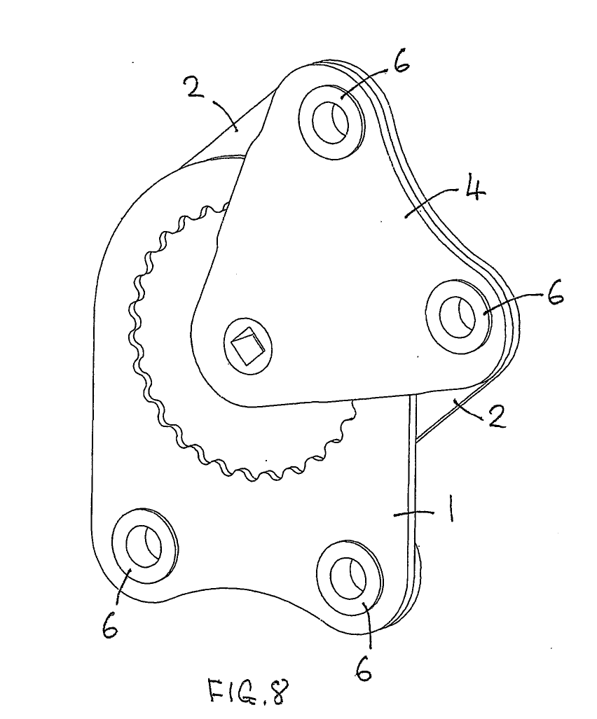

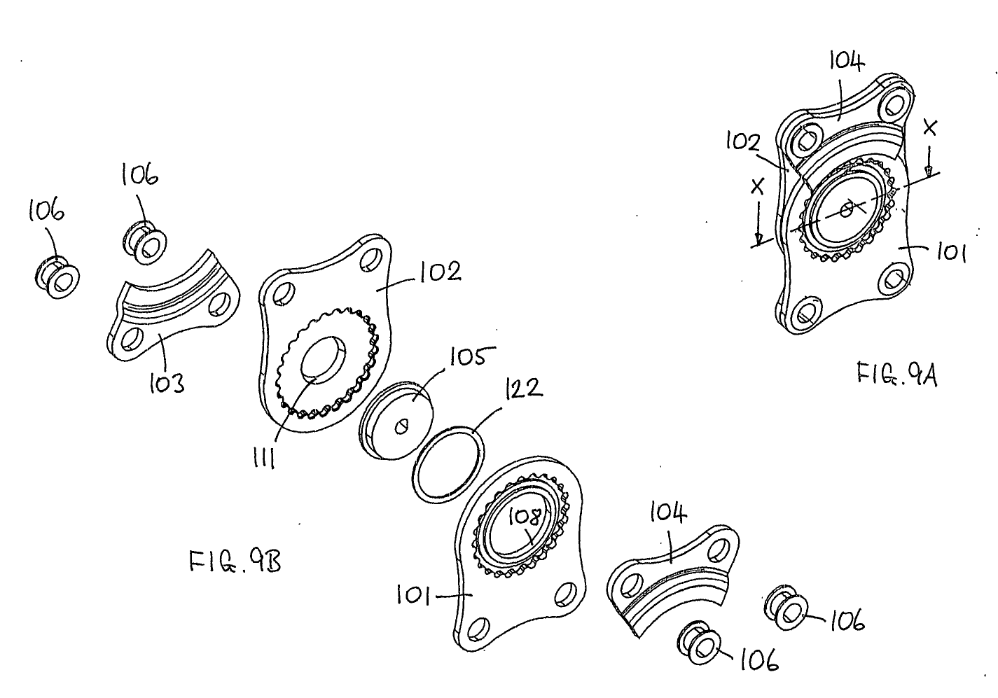

FIG. 4 is a second isometric view of the first recliner mechanism;

FIG. 5a is a front view and FIG. 5b is a side view of a cam;

FIGS. 6a and 6b are exploded and unexploded isometric views of the first recliner mechanism;

FIG. 7 is a side view of the first recliner mechanism in a partially reclined position;

FIG. 8 is an isometric view of the first recliner mechanism in a partially reclined position;

FIGS. 9a and 9b are exploded and unexploded isometric views of a second recliner mechanism;

FIG. 10 is a sectional view of the second recliner mechanism, on line X-X of FIG. 9b;

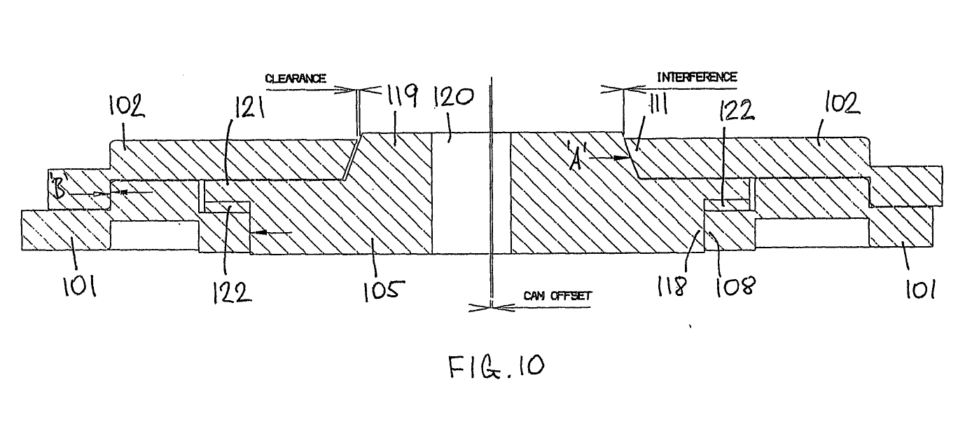

FIG. 11 is a side view of a third recliner mechanism;

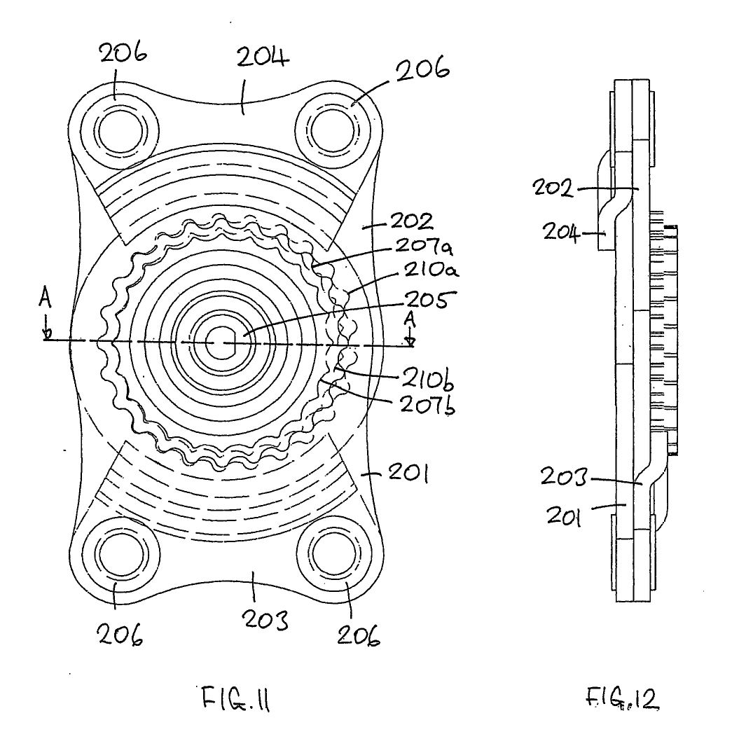

FIG. 12 is a front view of the third recliner mechanism;

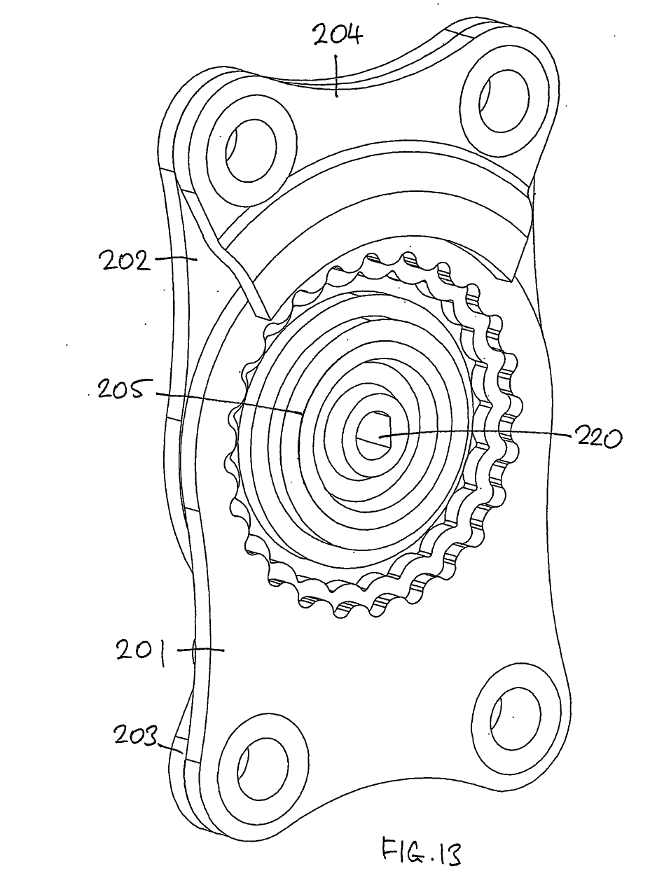

FIG. 13 is an isometric view of the third recliner mechanism;

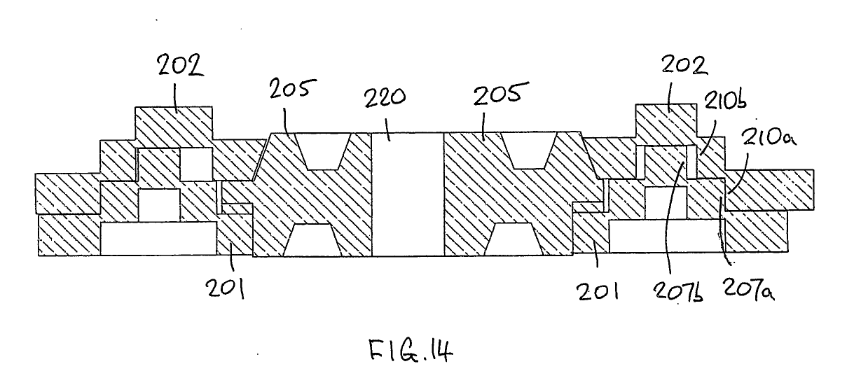

FIG. 14 is a sectional view of the third recliner mechanism, on line A-A of FIG. 11;

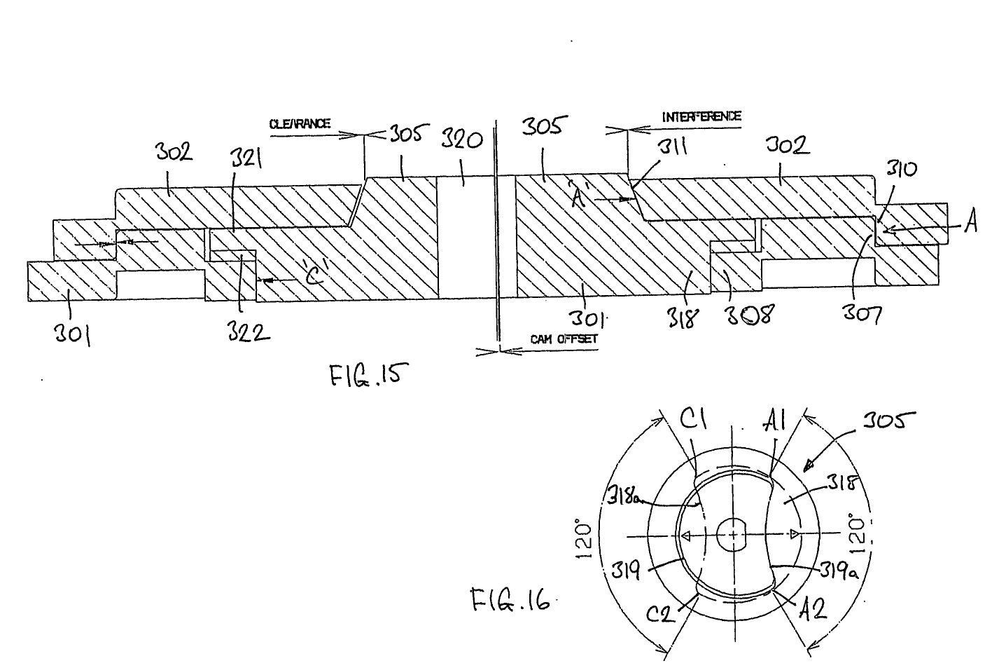

FIG. 15 is a sectional view of a fourth recliner mechanism;

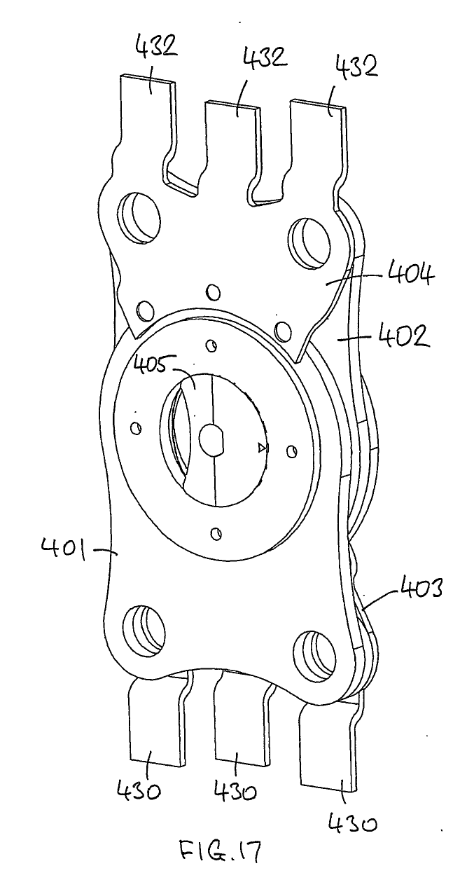

FIG. 16 is a side view of part of the fourth recliner mechanism;

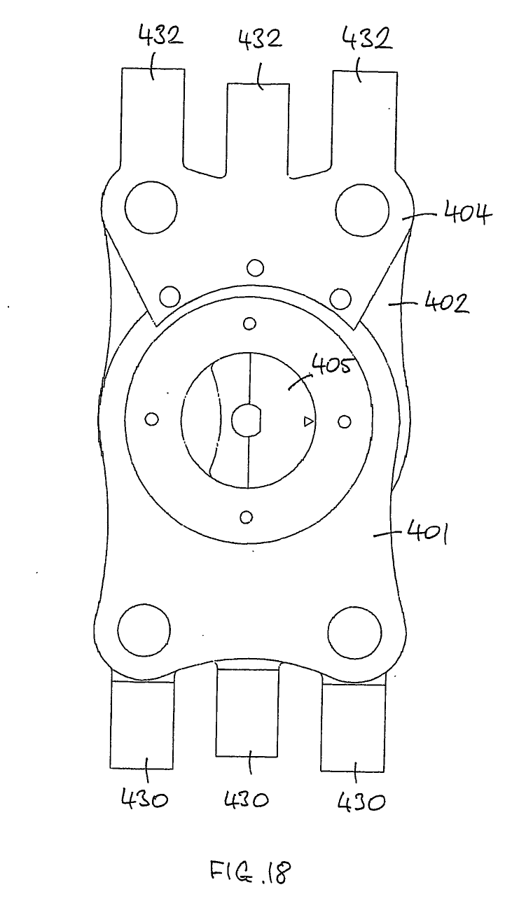

FIG. 17 is an isometric view of a fifth recliner mechanism;

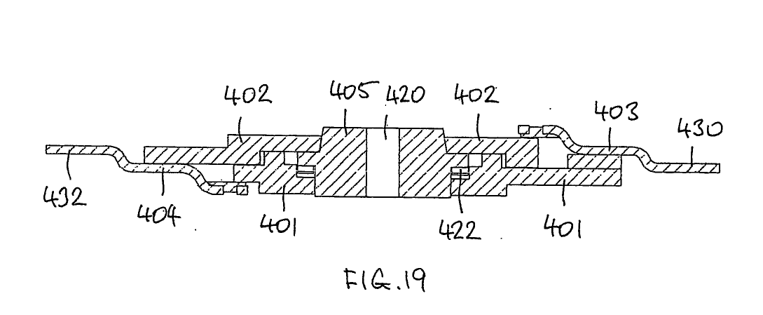

FIG. 18 is a side view of the fifth recliner mechanism, and

FIG. 19 is a sectional view of the fifth recliner mechanism, on line A-A of FIG. 17.

### FIRST EMBODIMENT

The vehicle seat shown schematically in FIG. 1 includes a seat cushion A, which is the part one sits on, a seat squab (or backrest) B, and a recliner mechanism C that connects the squab to the cushion and allows the angle of the squab B to be adjusted relative to the cushion A.

The first recliner mechanism shown in FIGS. 2 to 8 comprises a cushion plate 1, a squab plate 2, a cushion clamp plate 3, a squab clamp plate/pivot support 4, a special eccentric cam 5 and finally four through plate tubular rivets 6. The squab plate 2 and the cushion plate 3 carry a wobble gear mechanism, comprising an inner gear 7 and an outer gear 10.

The cushion plate 1 forms a stationary hinge element and is connectable to the frame of the seat cushion. The cushion plate 1 is a fine blanked component and carries the inner gear 7, which comprises an external tooth form semi-sheared out of the base material. In the centre of the gear is a hole 8, as shown in FIG. 3. Two holes at the bottom of the plate 9 are for the tubular rivets 6. The inner gear 7 has a very special conformal profile, similar to a Wildhaber-Novikov (WN) gear form. The gear shown here has 29 equally spaced teeth: it will be appreciated however that the gear may have more or fewer teeth than this.

The squab plate 2 forms an adjustable hinge element, which is connectable to the frame of the seat squab. The squab plate 2 is also a fine blanked component and carries the outer gear 10, which comprises an internal tooth form semi-sheared out of the base material. In the centre of the gear is a hole 11 that provides one side of a trunnion bearing for the eccentric cam 5. Two holes 12 at the top of the plate 2 are for the tubular rivets 6. The outer gear 10 also has a very special conformal profile that for all except one of the teeth gives a touch contact between that tooth and a corresponding tooth on the cushion plate 1. The outer gear 10 has one more tooth than the inner gear 7 and in this example it has 30 equally spaced teeth.

As can be seen most clearly in FIG. 2, the profiles of the outer gear 10 and the inner gear 7 are designed so that the teeth of the two gears make contact with one another around almost the entire circumference of the gears. Owing to the fact that the inner gear has one less tooth than the outer gear, the degree of engagement varies from one tooth to the next, such that the teeth are fully engaged on one side of the mechanism (at point X) and only one tooth on the opposite side (at point Z) is fully disengaged. This arrangement removes practically all free play (chuck) from the mechanism, within manufacturing tolerances.

The cushion clamp plate 3 is a simple toggled component. It has two holes 13 at the bottom through which pass the tubular rivets 6 which effectively clamp it onto the cushion plate 1. Through the tubular rivets pass the main fixing bolts (not shown) that attach the mechanism to the frame of the seat cushion. The clamp plate 3 includes an offset arcuate flange 14 that overhangs the squab plate 2 to stop the mechanism separating in use, whilst still allowing the squab plate to revolve.

The squab clamp plate/pivot support 4 is also a simple toggled component It has two holes 15 through which pass the tubular rivets 6 that effectively clamp it onto the squab plate 2. The clamp plate 4 includes an offset arm 16 that overhangs the cushion plate 1 to stop the mechanism separating in use, whilst still allowing it to revolve relative to the cushion plate 1.

At the lower end of the squab clamp plate 4 is a hole 17 through which passes the bearing of a cam 5. It will be apparent that the cam 5 is supported on one side by the hole 17 in the squab clamp plate 4 and on the other by hole 11 in squab plate 2.

Through the tubular rivets 6 pass the main fixing bolts (not shown) that attach the recliner mechanism to both the cushion and squab seat frames.

The special eccentric cam 5 is designed such that the special conformal tooth forms, developed for this mechanism automatically hold the engaged teeth (at point X) fully enmeshed because on the opposite side (at point Z) peak to peak contact is held Even the teeth that are not fully enmeshed urge the inner gear into engagement the outer gear. This is different from previous mechanisms where there is virtually no contact between the teeth of the inner and outer gears apart from at the point of full engagement, and where consequently the gears must be held in mesh by pressure from the central cam. FIG. 2 shows clearly the constant contact between opposed pairs of teeth around substantially the whole of the inner and outer gears, which is a very important feature of the present invention.

FIG. 5 shows a first form of the cam 5, which includes a cam profile 18 with a bearing 19 on each side. One can see that the cam profile is cut away on the left side and the right side. The curved surface at the top and bottom is designed to engage the hole 8 in cushion plate 1. Through the complete cam is a square hole 20 or similar. This hole is designed to accept a square shaft on which is mounted either a hand wheel or an electric motor with a reduction gearbox (not shown).

Looking at FIG. 5 one can see a centreline of rotation Cᵣ and a centreline of cam C_{c}. One can be forgiven for thinking that the centreline of rotation is the same as the rotation centreline of the hand wheel, however it is not. In this version of the mechanism, the fixed stationary point on the seat is on the centreline of the cam, and the centreline of rotation moves around the centreline of the cam in a circular motion, the radius of movement being the distance from centreline of the cam to the centreline of rotation. This distance is a very crucial dimension when defining the tooth profiles of the relative gear rings.

As the squab moves backwards or forwards, the centre of the mechanism is moving round and round. This gives a ‘waltzing’ movement (or ‘wobble’) to the squab, it is however very small and would not normally be noticeable.

Operation of the recliner mechanism will be explained with reference to FIGS. 2 and 7, where FIG. 2 shows the mechanism in a fully upright position and FIG. 7 shows it in a partially reclined position, with the squab plate 2 rotated through an angle of about 40°. It will be appreciated that in each case the position of maximum tooth engagement (point X) is determined by the rotational position of the cam 5 and that it rotates with the cam. Since the outer gear 10 has one more tooth than the inner gear 7, the cushion plate 1 advances by one tooth anti-clockwise for each clockwise revolution of the cam 5. In the example shown in the drawings, the outer gear 10 has 30 teeth, with an angular separation between adjacent teeth of 12°. The cam 5 therefore rotates through approximately 3.3 revolutions clockwise to produce a 40° anticlockwise rotation of the squab plate 2.

The conformal profiles of the outer gear 10 and the inner gear 7 are designed so that the teeth of the two gears make contact with one another around almost the entire circumference of the gears. Any loads transmitted through the mechanism are therefore shared by many teeth, which makes the mechanism very strong. Also as a result of the conformal tooth form, the loads are carried by the flanks rather than the tips of the teeth, which further increases the strength of the mechanism as compared to systems using involute gears. The strength of the mechanism may in certain cases be sufficient to allow the use of ordinary structural steel for the tooth forms, avoiding the need for case hardening. This in turn allows the mechanism to be welded direct to the seat frame without the need for expensive welding plates or adpators.

This arrangement of the conformal gears such that they are in contact around almost the entire circumference of the gears removes practically all free play (chuck) from the mechanism, within manufacturing tolerances, without the need for complex compensating mechanisms (wedges etc.). The amount of play allowed by the mechanism depends on the size of the peak-to-peak gap between the opposed teeth on the ‘free’ side of the mechanism (at point Z). Using the fine blanking technique, the inner and outer gears 7,10 can be manufactured to a tolerance of ±0.04 mm and the mechanism can therefore be designed to have a peak-to-peak gap of approximately 0.09 mm, to ensure non-jamming operation. This designed gap produces play at the top of a 500 mm squab of less than 1 mm.

### SECOND EMBODIMENT

The second recliner mechanism shown in FIGS. 9a, 9b and 10 is similar in many respects to the first recliner mechanism and the same reference numbers, incremented by 100, have been used for corresponding parts.

The second recliner mechanism comprises a cushion plate 101, a squab plate 102, a cushion clamp plate 103, a squab clamp plate 104, an eccentric cam 105 and four through plate tubular rivets 106.

The cushion plate 101 is a fine blanked component with an inner gear 107 semi-sheared out of the base material. In the centre of the gear is a hole 108 that provides the first side of a trunion bearing for the eccentric cam 105. Two holes at the bottom of the plate are for the tubular rivets 106. The gear 107 has 29 teeth equally spaced and with a profile that gives a touch contact with the teeth on the squab plate 102.

The squab plate 102 is a fine blanked component with an outer gear 110 semi-sheared out of the base material. In the centre of the gear is a hole 111 that provides the second side of a trunnion bearing for the eccentric cam 105. The hole 111 has a frusto-conical form with inclined walls, as shown in FIG. 10. Two holes 112 at the top of the plate 102 are for the tubular rivets 106. The gear 110 as shown has 30 equally spaced teeth, also with a profile that gives a touch contact point with the teeth on the cushion plate 101.

As in the first recliner mechanism, the profiles of the outer gear 110 and the inner gear 107 are designed so that the teeth of the two gears make contact with one another around substantially the entire circumference of the gears. Owing to the fact that the inner gear has one less tooth than the outer gear, the degree of engagement varies from one tooth to the next, such that the teeth are fully engaged on one side of the mechanism and only one pair of teeth is fully disengaged on the opposite side. This arrangement removes practically all free play (chuck) from the mechanism, within manufacturing tolerances.

The cushion clamp plate 103 is a simple toggled component having two holes 113 at the bottom through which pass the tubular rivets 106 to clamp it onto the cushion plate 101. Through the tubular rivets pass the main fixing bolts (not shown) that attach the mechanism to the cushion frame. The clamp plate 103 includes an offset arcuate flange 114 that overhangs the squab plate 102 to stop the mechanism separating in use, whilst still allowing the squab plate to revolve.

The squab clamp plate 104 is also a simple toggled component having two holes 115 through which pass the tubular rivets 106 to clamp it onto the squab plate 102. The clamp plate 104 includes an arcuate flange 116 that overhangs the cushion plate 101 to stop the mechanism separating in use, whilst still allowing the cushion plate 101 to revolve.

The cam 105 includes an eccentric circular cam profile 118 that is designed to engage the hole 108 in cushion plate 101. A frusto-conical bearing 119 provided on one face of the cam is designed to engage the frusto-conical hole 111 in the squab plate 102. Extending through the cam is a square hole 120 or similar. This hole is designed to accept a square shaft on which is mounted either a hand wheel or electric motor with a reduction gearbox (not shown). A circular flange 121 that extends outwards beyond the periphery of the cam profile is provided adjacent the face with the bearing 119.

A compressible element 122 is located on the circular cam profile 118 and is compressed between one face of the flange 121 and the opposed face of the cushion plate 101. The compressible element may be an annular friction disc made for example of a plastics material, or it may consist of a circular wave spring. The friction disc or spring provides a controlled degree of static friction, which helps prevent undesired rotation of the cam and any tendency of the squab to move during use of the vehicle. The degree of friction is however relatively low, so that it does not impede manual or motor-driven rotation of the cam when the position of the squab is being adjusted.

The compressed element 122 provides a thrust that acts axially on the cam 105, urging it towards the squab plate 102. The frusto-conical bearing 119 is offset marginally from its own defined central axis and it therefore provides a biasing force that acts radially on the squab plate 102 (at point “X” in FIG. 10). This encourages engagement of the pinion and crown teeth (at point “Z” in FIG. 10) and eliminates any tolerance between the cushion plate 101 and the squab plate 102 when the mechanism is stationary. It also helps to prevent jamming of the mechanism and relieves hard spots during adjustment.

As in the first embodiment, the centreline of rotation is offset from the centreline of the cam. The fixed stationary point on the seat is the centreline of rotation, and the centreline of the cam moves around the centreline of rotation in a circular motion, the radius of movement being the distance from centreline of the cam to the centreline of rotation. As the squab is adjusted backwards or forwards the centre of the mechanism rotates, giving a small ‘waltzing’ (or ‘wobble’) movement to the squab.

### THIRD EMBODIMENT

The third recliner mechanism shown in FIGS. 11 to 14 is similar in many respects to the second recliner mechanism and the same reference numbers, further incremented by 100 (i.e. starting with 201), have been used for corresponding parts.

The third recliner mechanism comprises a cushion plate 201, a squab plate 202, a cushion clamp plate 203, a squab clamp plate 204, an eccentric cam 205 and four through plate tubular rivets 206.

The cushion plate 201 is a fine blanked component with a primary inner gear 207a and a secondary inner gear 207b, both semi-sheared out of the base material. The primary inner gear 207a is of larger diameter than the secondary inner gear 207b, which has an inverted tooth form. In the centre of the gears is a hole 208 that provides the first side of a trunnion bearing for the eccentric cam 205. Two holes at the bottom of the plate are for the tubular rivets 206. Both gears 207a, 207b have 29 equally spaced teeth.

The squab plate 202 is a fine blanked component with a primary outer gear 210a and a secondary outer gear 210b semi-sheared out of the base material. The primary outer gear 210a is of larger diameter than the secondary outer gear 210b, which has an inverted tooth form. In the centre of the squab plate is a hole 211 that provides the second side of a trunnion bearing for the eccentric cam 205. The hole 211 has a frusto-conical form with inclined walls, as shown in FIG. 10. Two holes 212 at the top of the plate 202 are for the tubular rivets 206. Both outer gears 210a, 210b have 30 equally spaced teeth, with profiles that give touch contact points with the external teeth of the inner gears 207a, 207b on the cushion plate 201. The primary inner and outer gears 207a, 210a serve as the primary load carrier, and the secondary inner and outer gears 207b, 210b serve as the secondary load carrier, which provides additional strength in the event of an exceptionally high load (for example in a collision).

As in the first recliner mechanism, the profiles of the primary gears 207a and 210a are designed so that the teeth of the two gears make contact with one another around substantially the entire circumference of the gears. Owing to the fact that the inner gear has one less tooth than the outer gear, the degree of engagement varies from one tooth to the next, such that the teeth are fully engaged on one side of the mechanism and only one tooth is fully disengaged on the opposite side. This arrangement removes practically all free play (chuck) from the mechanism, within manufacturing tolerances.

The profiles of the secondary gears 207b and 210b are designed so that the teeth of the two gears do not normally make contact with one another. The secondary gears come into engagement only when the seat back is subjected to an abnormally high load, for example during an accident, that causes deformation of the teeth on the primary gears. The secondary gears then provide additional strength, to prevent the seat back from collapsing.

The cushion clamp plate 203 is a simple toggled component having two holes 213 at the bottom through which pass the tubular rivets 206 to clamp it onto the cushion plate 201. Through the tubular rivets pass the main fixing bolts (not shown) that attach the mechanism to the cushion frame. The clamp plate 203 includes an offset arcuate flange 214 that overhangs the squab plate 202 to stop the mechanism separating in use, whilst still allowing the squab plate to revolve.

The squab clamp plate/pivot support 204 is also a simple toggled component having two holes 215 through which pass the tubular rivets 206 to clamp it onto the squab plate 202. The clamp plate 204 includes an arcuate flange 216 that overhangs the cushion plate 201 to stop the mechanism separating in use, whilst still allowing the cushion plate 201 to revolve.

The cam 205 includes an eccentric circular cam profile 218 that is designed to engage the hole 208 in cushion plate 201. A frusto-conical bearing 219 provided on one face of the cam is designed to engage the frusto-conical hole 211 in the squab plate 202. Extending through the cam is a D-shaped hole 220 or similar. This hole is designed to accept a D-shaped shaft on which is mounted either a hand wheel or an electric motor with a reduction gearbox (not shown). A circular flange 221 that extends outwards beyond the periphery of the cam profile is provided adjacent the face with the bearing 219. Optionally, an annular friction disc or wave spring (not shown) may be located on the circular cam profile 218 between one face of the flange 221 and the opposed face of the cushion plate 201.

### FOURTH EMBODIMENT

A fourth recliner mechanism is shown in FIGS. 15 and 16. The recliner mechanism includes a cushion plate 301, a squab plate 302, a compressible element 322 such as a wave spring, and an eccentric cam 305. A cushion clamp plate, a squab clamp plate/pivot support and four through plate tubular rivets are also provided, but these components are omitted from the drawings for clarity.

The cushion plate 301 and the squab plate 302 are fine blanked components and are substantially as described above with reference to the first recliner mechanism. The cushion plate 301 has an inner gear 307 that engages an outer gear 310 formed in the squab plate 302. The profiles of the outer gear 310 and the inner gear 307 are designed so that the teeth of the two gears make contact with one another around almost the entire circumference of the gears, the teeth being fully engaged on one side of the mechanism (at point X) and just one tooth being fully disengaged on the opposite side (at point Z). In the centre of the squab plate 302 is a hole 311 that provides one side of a trunnion bearing for the eccentric cam 305. This hole 311 has a frusto-conical form with inclined walls set at an angle in the range 7-10°, preferably approximately 9°. A hole 308 with upright walls formed in the cushion plate 301 provides the other side of the trunnion bearing.

The cam 305 includes a first cam profile 318 that engages the hole 308 in the cushion plate 301 and an offset second cam profile 319 with inclined walls that engages the frusto-conical hole 311 in the squab plate 302. The first and second cam profiles 318, 319 both include a circular cam surface with a cut-out portion 318a, 319a, the ends of each cut-out portion being separated by an angle of approximately 120°. The cut-out portions 318a, 319a are located on opposite sides of the cam 305, each cut-out portion being located on the side of the cam that exerts a force on one of the cushion plate 301 and the squab plate 302. The forces ‘A’ and ‘C’ exerted by the cam on each of the cushion plate 301 and the squab plate 302 are both therefore spread between two contact points: A1,A2 and C1,C2. This helps to improve the stability of the mechanism.

Extending through the cam is a D-shaped hole 320. This hole accepts a shaft on which is mounted either a hand wheel or an electric motor with a reduction gearbox (not shown). A circular flange 321 extends radially outwards between the first and second cam profiles. A compressible element 322 such as a plastic ring or a wave spring is compressed between the flange 321 and a face of the cushion plate 301.

### FIFTH EMBODIMENT

A fifth recliner mechanism is shown in FIGS. 17, 18 and 19. The recliner mechanism includes a cushion plate 401, a squab plate 402, an eccentric cam 405, a cushion clamp plate 403, a squab clamp plate/pivot support 404 and a wave spring 422. Four through plate tubular rivets are also provided, but are not shown in the drawings. The above-mentioned components are all similar to the corresponding components of the fourth recliner mechanism, except as described below.

The cushion clamp plate 403 is made of normal structural steel and includes three welding tabs 430 that extend downwards beyond the edge of the cushion plate 401. Similarly, the squab clamp plate 404 is also made of normal structural steel and includes three welding tabs 432 that extend upwards beyond the edge of the squab plate 402. The welding tabs 430,432 allow the recliner mechanism to be welded directly to the frame of a vehicle seat without the need for expensive adaptor plates, even if the cushion plate 401 and the squab plate 402 are made of case hardened steel.

Various modifications of the mechanism described above are of course possible. For example, the gear rings and other components of the mechanism may be made using alternative manufacturing methods, such as blanking, broaching, eroding and so on. Various of the components, for example the cam 305, may also have alternative forms or shapes, according to their specific requirements.

1. A seat recliner mechanism for a seat having a seat cushion and a reclinable squab, the mechanism comprising a stationary hinge member connectable with the seat cushion, an adjustable hinge member connectable with the squab and an angular position adjuster in the form of a wobble gear mechanism comprising an inner gear connected to one of the hinge members, an outer gear connected to the other hinge member and an eccentric rotatable drive element for causing eccentric rotation of the inner gear within the outer gear, wherein the outer gear has one more tooth than the inner gear and the inner and outer gears have conformal tooth profiles, whereby all but one of the teeth on the inner gear engage with teeth on the outer gear.

2. The seat recliner mechanism according to claim 1, wherein the maximum peak-to-peak gap between the teeth of the inner and outer gears is less than 0.15 mm.

3. The seat recliner mechanism according to claim 1, wherein the inner and outer gears have a tooth form similar to a Wildhaber-Novikov tooth form.

4. The seat recliner mechanism according to claim 1, wherein the rotatable drive element comprises an eccentric cam.

5. The seat recliner mechanism according to claim 4, wherein the cam surface of the eccentric cam is partly cut away.

6. The seat recliner mechanism according to claim 1 wherein the rotatable drive element is mounted in a frusto-conical bearing.

7. The seat recliner mechanism according to claim 6, wherein the frusto-conical bearing has bearing surfaces inclined at an angle of 7-10°, relative to the rotational axis of the bearing.

8. The seat recliner mechanism according to claim 1 wherein a compressible element is compressed between the rotatable drive element and one of the hinge members.

9. The seat recliner mechanism according to claim 8, wherein the compressible element includes comprises a plastics ring or a wave spring.

10. The seat recliner mechanism according to claim 1, further comprising a secondary gear mechanism that includes comprises a secondary inner gear connected to one of the hinge members and a secondary outer gear connected to the other hinge member, said secondary inner and outer gears being arranged to come into engagement only when the recliner mechanism is deformed.

11. The seat recliner mechanism according to claim 1, wherein the gears are semi-sheared out of the hinge members.

12. The seat recliner mechanism according to claim 1, wherein said hinge members comprise welding tabs for welding direct to frame members of the seat cushion and squab.

13. The seat recliner mechanism according to claim 1, wherein the maximum peak-to-peak gap between the teeth of the inner and outer gears is less than 0.1 mm.

14. The seat recliner mechanism according to claim 6, wherein the frusto-conical bearing has bearing surfaces inclined at an angle of approximately 9°, relative to the rotational axis of the bearing.
